(19) United States
(12) Patent Application Publication
(10) Pub. No.: US 2025/0383828 A1
(43) Pub. Date: Dec. 18, 2025

(54) SUPPLEMENTAL DISPLAY FOR INTERACTIVE CONTENT

(71) Applicant: Innovative Point of Sale Systems, LLC, Boise, ID (US)

(72) Inventors: William Jonathan Carter, Boise, ID (US); Evan Hsu, Boise, ID (US); Scott Sword, Boise, ID (US)

(73) Assignee: Watchly, LLC, Boise, ID (US)

(21) Appl. No.: 19/240,603

(22) Filed: Jun. 17, 2025

Related U.S. Application Data
(60) Provisional application No. 63/660,750, filed on Jun. 17, 2024.

(51) Int. Cl. G06F 3/14; G06F 3/16

(52) U.S. Cl. CPC G06F 3/1446; G06F 3/167

(57) ABSTRACT

Disclosed embodiments include systems and methods for displaying supplemental interactive content. Embodiments include a first display screen for displaying a first content and a second display electronically connected to communicate with the first display. The second display includes a processing module including a processor and processing instructions, and wherein the processing module identifies the first content being displayed on the first display screen and causes the second display to display supplemental interactive content related to the first content.

### CROSS-REFERENCE TO RELATED APPLICATIONS

This application, under 35 U.S.C. § 119, claims the benefit of U.S. Provisional Patent Application Ser. No. 63/660,750 filed on Jun. 17, 2024, and entitled “Supplemental Display For Interactive Content,” the contents of which are hereby incorporated by reference herein.

### FIELD OF THE DISCLOSURE

This disclosure relates generally to information display. More particularly, this disclosure relates to information display on a secondary digital screen in proximity to another screen.

### BACKGROUND

For existing sports wagering or betting arrangements one typically must be present in the casino, on a betting website, or otherwise separately in contact with a betting place. This can be inconvenient and limits the types of sports wagering that can be conducted.

### SUMMARY

Disclosed embodiments include a secondary digital screen attached or arranged in such a manner that the secondary digital screen is adjacent to or in close proximity to another screen (called for convenience herein the “TV screen,” though it need not be displaying content from a “television signal” but instead is any surface or screen including but not limited to tablets, computers, laptops, televisions, monitors and any other “liquid crystal” display or technology that achieves the same result) displaying a live sporting event, an awards show (e.g., the “Oscars” or “Golden Globes”), a contest (e.g., Ms. America, Ms. Universe), or the like. The secondary digital screen attached to the TV screen displays “intra” event wagers that can be placed, such as, but not limited to, total yards in the first quarter, outcome of coin toss, passing yards, rushing yards, baskets scored, hits, pitches, best picture, best actor, and the like. As those of ordinary skill in the art having the benefit of this disclosure will recognize, any aspect of a game or event that a viewer would want to, or could, wager on may be displayed on the secondary digital screen. Embodiments of the secondary digital screen also display the payouts for each bet, a QR code for accessing any place which accepts wagers.

In some embodiments, when a game or event broadcast on the TV screen changes (by the event ending, changing the channel, switching TV screen inputs, etc.), then the bets and payout information displayed on the secondary digital screen would update to the new game or event. For example, if the TV screen is initially displaying USC vs Arizona college football game and the channel is subsequently changed to Alabama vs Georgia college football game, the wagers, payouts, etc., on the secondary digital screen would change/update in order to be relevant to the content being displayed on the TV screen display.

In some embodiments the secondary digital screen may also display a QR code, link or the like, allowing the viewer to go directly to the sports book website and place one or more of the bets displayed on the secondary screen. Other embodiments also exist.

### BRIEF DESCRIPTION OF THE DRAWINGS

FIG. 1 is a schematic illustration of a system for displaying supplemental interactive content in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

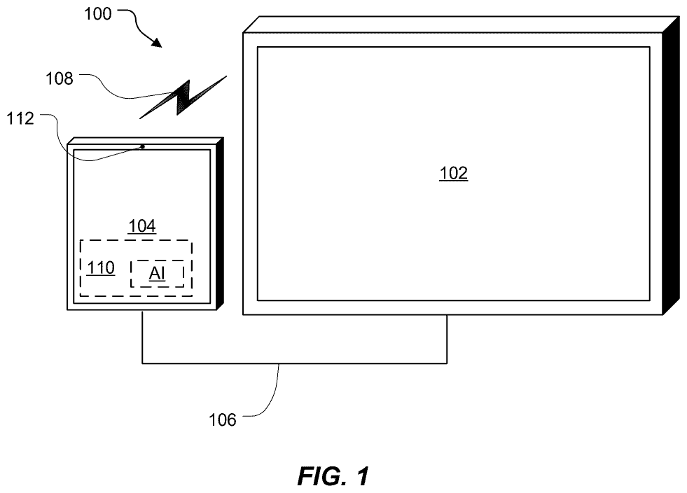

FIG. 1 is a schematic illustration of a system 100 for displaying supplemental interactive content in accordance with disclosed embodiments. As illustrated a TV screen 102 is used to display a live sporting or other event. As used herein “live” means substantially synchronous with the sporting or other event as it is occurring for substantially all viewers. A few second delay for broadcasting purposes is considered substantially live for purposes of this disclosure. Further, the means of distributing the sporting or other event does not alter the scope of the claims. Sporting or other events, whether broadcast via traditional television or live streaming events directly, through the Internet, “live” casts directly from the source such as “NFL.com”, displays on paid for subscription sites such as “YouTube,” “Hulu,” “Netflix,” and the like and any future version of content distribution to a TV screen

Embodiments of system 100 also include secondary digital screen 104 for displaying the interactive content (e.g., intra event bets, odds, bet amounts, payouts, promotions, advertisements, offers, etc.) as disclosed herein. As shown, embodiments of secondary digital screen 104 are typically smaller in size than TV screen 102. In some embodiments, secondary digital screen 104 may be physically attachable and unattachable to TV screen 102, for example, in a manner similar to those disclosed in U.S. Pat. No. 10,107,777, which is herein incorporated by reference in its entirety. Secondary digital screen 104 may be mounted to the front, side, top, or bottom of TV screen 102, or to the back of another screen, or wall mounted, in such a way that the two screens are arranged to be generally simultaneously viewable. In some embodiments, secondary digital screen 104 may be portable, hand-held, stand on its own, or in a cradle, or stand, or the like.

As indicated schematically, TV screen 102 and secondary digital screen 104 are in communication either by a wired connection 106 or a wireless connection 108 (e.g., Bluetooth, Wi-Fi, or the like). As also indicated schematically, embodiments of secondary digital screen 104 may include processing module 110 with appropriate hardware (e.g., processors), software or firmware (e.g., processor instructions), and peripheral devices (e.g., speakers, microphones, transmitters, antennae, timers, and the like) sufficient to carry out the functions disclosed herein.

In some embodiments the secondary digital screen 104 knows which game is playing on the TV screen 102 by tapping into the data stream going to the TV screen 102, either by wire 106 or wirelessly 108 and identifying, via processing module 110, the data that identifies the game or sporting or other event being broadcast. In some embodiments, processing module 110 may include an AI component as indicated schematically (and the secondary digital screen 104 includes associated microphones 112) to listen to the audio from the TV screen 102 and “hear” the names of players, know the date and time, search a channel directory and conclude that the TV is broadcasting X vs Y contest and then display the appropriate wagers, odds, payouts and other information disclosed herein on the secondary digital screen 104. In still other embodiments, processing module 110 may also include an appropriate TV tuner-like device to manually, or automatically, set the secondary digital screen 104 to correspond to the correct input for the TV screen 102.

Similarly, embodiments of system 100 may enable manually setting the secondary digital screen 104 and TV screen 102 to show betting that corresponds to a specific game, for example, by choosing from the top 25 college football games that day, or the scheduled Sunday NFL games, or the like.

In some embodiments of system 100 when a game or other live event broadcast ends, or the TV screen 102 channel is changed to a non-live event (e.g., a situation comedy, movie, or the like), the secondary digital screen 104 will then be used to broadcast digital advertising that may, or may not, be related to the TV screen 102 broadcast. In some embodiments secondary digital screen 104, when not displaying bets, odds, and the like, may display advertisements for a specific betting platform (e.g., Fan Duel, Draft Kings, a specific casino, or the like) or for third party products and services.

Embodiments of processing module 110 include the ability to receive remote data (e.g., the betting odds) from a source (e.g., the betting platform or sports book) via the internet, ethernet, cellular signal or some other electronic communication. As noted, embodiments of secondary digital screen 104 also are able to display messages, text, numbers, unrelated advertising, weblinks, a QR code or any equivalent scannable code that when scanned by a camera in a mobile phone or other device provides a link or automatic connection to a website.

Embodiments of TV screen 102 may be a conventional screen, monitor or electronic digital display device capable of displaying content such as a sporting or other event where the source of the content is a signal transmitted electronically via internet, ethernet, cellular, coaxial cable, satellite transmission, radio-frequency transmission, or other means.

Other embodiments also exist.

Although various embodiments have been shown and described, the present disclosure is not so limited and will be understood to include all such modifications and variations would be apparent to one skilled in the art.

What is claimed is:

1. A system for displaying supplemental interactive content, the system comprising:
a first display screen for displaying a first content;
a second display electronically connected to communicate with the first display;
the second display further comprising a processing module including a processor and processing instructions; and
wherein the processing module identifies the first content being displayed on the first display screen and causes the second display to display supplemental interactive content related to the first content.

2. The system of claim 1 wherein the supplemental interactive content comprises interactive wagering content.

3. The system of claim 1 wherein the second display is a different size than the first display.

4. The system of claim 3 wherein the second display is smaller than the first display.

5. The system of claim 1 wherein the first content comprises a sporting event and the supplemental interactive content comprises interactive sports betting content.

6. The system of claim 5 wherein the sporting event is displayed in a substantially live manner and the interactive sports betting content comprises intra-event betting.

7. The system of claim 1 wherein the second display includes a microphone and the processing module further comprises an Artificial Intelligence (AI) component that uses the microphone to listen to the audio from the first display and identify the first content and then display the supplemental interactive content related to the first content.

8. The system of claim 1 wherein the processing module further comprises a TV tuner-like device to manually, or automatically, set the secondary digital display to display supplemental interactive content related to the first content.

9. The system of claim 6 wherein when the sporting event ends the secondary digital display changes the supplemental interactive content to digital advertising that may, or may not, be related to current first content being displayed on the first display.

10. The system of claim 9 wherein the digital advertising comprises advertisements for a specific betting platform or for third party products and services.

11. A method for displaying supplemental interactive content, the method comprising:
displaying on a first display screen a first content;
communicating between a second display electronically connected to the first display;
the second display further comprising a processing module including a processor and processing instructions; and
wherein the processing module identifies the first content being displayed on the first display screen and causes the second display to display supplemental interactive content related to the first content.

12. The method of claim 11 wherein the supplemental interactive content comprises interactive wagering content.

13. The method of claim 11 wherein the second display is a different size than the first display.

14. The method of claim 13 wherein the second display is smaller than the first display.

15. The method of claim 11 wherein the first content comprises a sporting event and the supplemental interactive content comprises interactive sports betting content.

16. The method of claim 15 wherein the sporting event is displayed in a substantially live manner and the interactive sports betting content comprises intra-event betting.

17. The method of claim 11 wherein the second display includes a microphone and the processing module further comprises an Artificial Intelligence (AI) component that uses the microphone to listen to the audio from the first display and identify the first content and then display the supplemental interactive content related to the first content.

18. The method of claim 11 wherein the processing module further comprises a TV tuner-like device to manually, or automatically, set the secondary digital display to display supplemental interactive content related to the first content.

19. The method of claim 16 wherein when the sporting event ends the secondary digital display changes the supplemental interactive content to digital advertising that may, or may not, be related to current first content being displayed on the first display.

20. The method of claim 19 wherein the digital advertising comprises advertisements for a specific betting platform or for third party products and services.
